(19) United States
(12) Patent Application Publication
(10) Pub. No.: US 2007/0246993 A1
(43) Pub. Date: Oct. 25, 2007

(54) Chairs of a chairlift having protection against sliding out

(75) Inventor: Kurt Switzeny, Brunnen (CH)

Correspondence Address: LERNER GREENBERG STEMER LLP, P O BOX 2480, HOLLYWOOD, FL, 33022-2480, US

(73) Assignee: Innova Patent GmbH

(21) Appl. No.: 11/786,804

(22) Filed: Apr. 13, 2007

(30) Foreign Application Priority Data
Apr. 13, 2006 (AT) 646/2006

(51) Int. Cl. B60R 21/00; B61B 3/00; B61B 7/00; B61B 11/00

(52) U.S. Cl. 297/487; 105/149.2

(57) ABSTRACT

In order to prevent individuals from sliding or falling out of a chair of a chairlift, irrespective of their size and sitting position, the seat surface has regions of increased slip resistance. Either the seat surface has a higher level of slip resistance in the region of its front edge than in the region of its rear edge or the region of the seat surface has a higher level of slip resistance than the backrest. It is ensured, in particular, that smaller persons, who slide into the region of the front edge of the seat surface, are held securely.

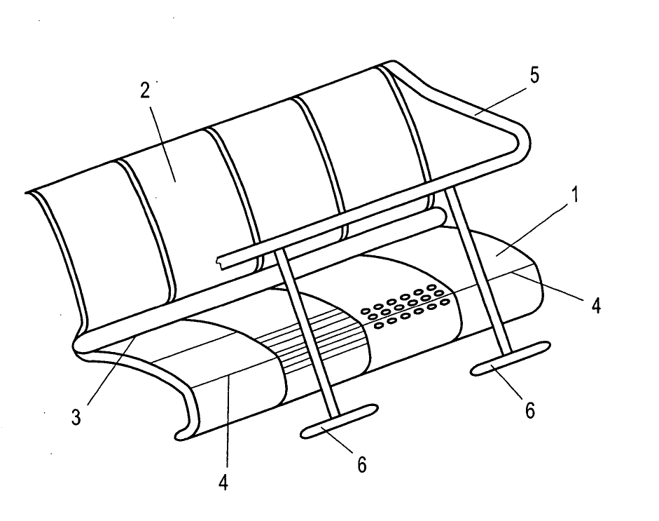

### CROSS-REFERENCE TO RELATED APPLICATION

This application claims the priority, under 35 U.S.C. § 119, of Austrian application A 646/2006, filed Apr. 13, 2006; the prior application is herewith incorporated by reference in its entirety.

### BACKGROUND OF THE INVENTION

### FIELD OF THE INVENTION

The invention relates to chairs of a chairlift having at least one seat with a seat cushion, which has a seat surface, and with a backrest, the seat surface having a rear edge adjacent to the backrest and a front edge located opposite the rear edge.

Chairs for chairlifts usually have four to eight seats located one beside the other. In order to prevent the passengers from falling or sliding out of the chair, these chairs have closure bars extending over the entire width of the chair. The closure bars can be pivoted from a position in which they are located above the passengers into a position in which a crossbar extends in front of the passengers, above their thighs. A number of foot rests corresponding to the number of seats are also usually provided on the closure bars.

Smaller individuals, such a children in particular, are often not able to assume the correct sitting position, in which one's entire back is supported on the backrest, and they therefore want to hold onto the closure bar, in particular the crossbar, as a result of which their bottom moves into the region of the front edge of the seat surface. Since the spacing between the crossbar and seat surface, as stipulated by the regulations, is dimensioned such that it is also possible for tall passengers with relatively long legs to fit comfortably beneath the crossbar, this spacing is usually too large for smaller individuals, in which case it is possible that these smaller individuals will slip through under the crossbar, in particular if their shorter legs mean that they are unable to support them on the foot rests.

The risk of sliding out, in particular if an incorrect sitting position is assumed, is increased by the seat surfaces usually being smooth and slippery when wet. It is only special installations provided primarily for transporting children which can provide for design measures in order to reduce the spacing between the crossbar and seat surface to the extent where sliding out can largely be prevented.

Prior solutions to reduce the slide-out risk are described in commonly assigned Austrian patent AT 411 523 B and its counterpart U.S. Pat. No. 6,691,624 B2, and in Austrian patent AT 411 046 B. The measures which are known from these prior publications can essentially be summarized to the effect that protective brackets or cams are arranged between the thighs of the respective user. However, this does not provide protection if a small passenger is seated in such a way that this protective bracket or the cam is located alongside him rather than between his legs.

### SUMMARY OF THE INVENTION

It is accordingly an object of the invention to provide a chair for a chairlift with slide-out protection, which overcomes the above-mentioned disadvantages of the heretofore-known devices and methods of this general type and which reliably prevents an individual, irrespective of his or her size and sitting position on the chair, from slipping through between the seat surface and crossbar.

With the foregoing and other objects in view there is provided, in accordance with the invention, a chair of a chairlift, comprising:

at least one seat with a seat cushion having a seat surface;

a backrest;

the seat surface having a rear edge adjacent the backrest and a front edge distally from the rear edge;

the seat surface having an increased slip resistance in a region of the front edge as compared to a region of the rear edge.

In the alternative, or in addition, the seat surface has a higher slip resistance than the backrest, i.e., the surface of the backrest.

If the seat surface, according to the invention, has a higher level of slip resistance in the region of the front edge than in the region of the rear edge, this prevents passengers from sliding out of the seat, in particular even if an incorrect sitting position is assumed, since the region of the front edge is particularly critical for smaller individuals such as children sliding out.

In preferred embodiments of the invention, it is possible, in the region of increased slip resistance, for the seat surface either to consist of a material of increased slip resistance or to be formed from an additional layer of increased slip resistance, both cases ensuring that individuals are held reliably irrespective of their size.

According to the invention, it may also be provided that the region of the seat surface has a higher level of slip resistance than the backrest, this preventing passengers from sliding out, in particular even if an incorrect sitting position is assumed.

In a particularly reliable embodiment, the region of increased slip resistance extends over the entire surface area of the seat surface, this avoiding not just sliding from the front edge, but also sliding in the direction of the front edge.

It is also possible for existing chairlift installations to be easily and cost-effectively retrofitted with seat surfaces according to the invention.

Other features which are considered as characteristic for the invention are set forth in the appended claims.

Although the invention is illustrated and described herein as embodied in chairs of a chairlift having protection against sliding out, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing is a partial perspective view of a lift chair with a closure bar in a closed position.

### DESCRIPTION OF THE PREFERRED EMBODIMENT:

Referring now to the drawing in detail, the sole figure illustrates only those parts which are relevant to the invention. The rest of the parts of the chair may be configured in the manner already known from the prior art. It will thus just be mentioned in general terms that the chair has a seat bench and a closure bar which are fastened on a load-bearing frame. The frame is connected, possibly via an articulation, to a load-bearing bar, at the top end of which is fitted a clamping arrangement for fastening or coupling the chair to a supporting and/or haulage cable. If required, it is also possible to provide a running-gear mechanism at the top end of the load-bearing bar, this mechanism serving for displacing the chair through the boarding and disembarking regions, along rails provided in the stations, once the chair has been uncoupled from the supporting and/or haulage cable.

The figure shows parts of a chair according to the invention with the seat bench, of which four seats are shown. Each seat has a seat cushion 1 and a backrest 2 arranged at an angle to the seat cushion. The seat cushion 1 has a seat surface which has a rear edge 3 adjacent to the backrest 2 and a front edge 4 located opposite the rear edge 3, the front edge usually being rounded. Running parallel to the row of seats is the closure bar, which has a crossbar 5 and foot rests 6 assigned to the seats.

In the figure, the three seat surfaces on the left have a higher level of slip resistance in the region of their front edge 4 than in the region of the rear edge 3. The regions of increased slip resistance may be formed from a continuous, sheet-like material (the left-hand seat surface), for example a smooth film or a non-slip woven fabric. As an alternative, or in addition, it is also possible to provide material of increased slip resistance which is applied, in particular injection molded, at certain points and/or in linear fashion.

Within the context of the invention, the seat surface thus forms the surface of the seat cushion 1, which consists partly of a material which is conventional for seat surfaces of chairlifts and partly of a material of increased slip resistance, and which forms the surface of contact between the chair and an individual sitting on it.

In addition to smooth and profiled seat-surface regions of increased slip resistance, it is also possible for these regions, in the context of the invention, to have other kinds of surfaces, for example rough surfaces.

As indicated, for example, by the three seats on the left, the region of increased slip resistance may correspond approximately to half (left-hand seat), a third (second seat from the left) or a quarter (second seat from the right) of the seat surface. It is also possible for this region to be smaller still and to correspond, for example, just to an eighth or a tenth of the seat surface. In further embodiments (not shown) this region may be distributed as desired over the seat surface and even extend over the entire surface area of the seat surface (right-hand seat). In the last-mentioned case, the seat surface has a higher level of slip resistance than the backrest 2.

The primary concept of the invention is that the non-slip part extends in the region, or into the region, of the front edge 4, since this is the most critical region for individuals sliding out.

Depending on the material of increased slip resistance, and the extent of this material over the seat surface, suitable means and methods may be provided in order to connect this material in a permanent or removable manner to the seat cushion 1. It is thus possible for the material to be connected to the seat cushion 1 in the region of the front edge 4 of the seat surface, or also over the entire surface area of the seat surface, for example with the aid of a touch-and-close fastener or by adhesive bonding and/or sewing and/or welding and/or riveting and/or screw connection.

It is also possible for the material of increased slip resistance to replace the rest of the material of the seat surface in the relevant regions.

To summarize, an exemplary embodiment of the invention may be described as follows:

In order to prevent individuals from sliding or falling out of a chair for a chairlift, irrespective of their size and sitting position, the seat surface has regions of increased slip resistance. For this purpose, either the seat surface has a higher level of slip resistance in the region of its front edge 4 than in the region of its rear edge 3 or the region of the seat surface has a higher level of slip resistance than the backrest 2.

It is also ensured, in particular, that smaller individuals, who slide into the region of the front edge 4 of the seat surface, are held securely.

I claim:

1. A chair of a chairlift, comprising:
at least one seat with a seat cushion having a seat surface;
a backrest;
said seat surface having a rear edge adjacent said backrest and a front edge distally from said rear edge;
said seat surface having an increased slip resistance in a region of said front edge as compared to a region of said rear edge.

2. The chair according to claim 1, wherein, in the region of the increased slip resistance, said seat surface consists of a material having a higher level of slip resistance than the material in the region of said rear edge.

3. The chair according to claim 1, wherein, in the region of the increased slip resistance, said seat surface is formed from an additional layer having a higher level of slip resistance than the material in the region of said rear edge.

4. The chair according to claim 2, wherein, in the region of the increased slip resistance, said seat surface is formed of a continuous sheet material of increased slip resistance relative to a remaining area.

5. The chair according to claim 3, wherein, in the region of the increased slip resistance, said seat surface includes a material of increased slip resistance applied thereon at certain points and/or in linear fashion.

6. The chair according to claim 3, wherein the region of said seat surface with increased slip resistance is permanently connected to said seat cushion.

7. The chair according to claim 3, wherein the region of said seat surface with increased slip resistance is removably connected to said seat cushion.

8. The chair according to claim 1, wherein the region of said seat surface having the increased slip resistance is substantially smooth.

9. The chair according to claim 1, wherein the region of said seat surface having the increased slip resistance has a rough surface.

10. The chair according to claim 1, wherein the region of said seat surface having the increased slip resistance is profiled.

11. The chair according to claim 1, wherein the region of said seat surface having the increased slip resistance corresponds substantially to a surface area selected from the group consisting of ½, ⅓, ¼, ⅛, or 1/10 of an extent of a surface area of said seat surface.

12. A chair of a chairlift, comprising:
at least one seat with a seat cushion having a seat surface;
a backrest;
said seat surface having a rear edge adjacent said backrest and a front edge distally from said rear edge;
wherein said seat surface has a region with a higher level of slip resistance than said backrest.

13. The chair according to claim 12, wherein said region with an increased slip resistance relative to a slip resistance of said backrest extends over an entire surface area of said seat surface.

14. The chair according to claim 12, wherein, in the region of the increased slip resistance, said seat surface consists of a material having a higher level of slip resistance than a material of said backrest.

15. The chair according to claim 1, wherein, in the region of the increased slip resistance, said seat surface is formed from an additional layer having a higher level of slip resistance than a material of said backrest.

16. The chair according to claim 12, wherein, in the region of the increased slip resistance, said seat surface is formed of a continuous sheet material of increased slip resistance relative to said backrest.

17. The chair according to claim 15, wherein, in the region of the increased slip resistance, said seat surface includes a material of increased slip resistance applied thereon at certain points and/or in linear fashion.

18. The chair according to claim 12, wherein the region of said seat surface with increased slip resistance is permanently connected to said seat cushion.

19. The chair according to claim 12, wherein the region of said seat surface with increased slip resistance is removably connected to said seat cushion.

20. The chair according to claim 12, wherein the region of said seat surface having the increased slip resistance is substantially smooth.

21. The chair according to claim 12, wherein the region of said seat surface having the increased slip resistance has a rough surface.

22. The chair according to claim 12, wherein the region of said seat surface having the increased slip resistance is profiled.

23. The chair according to claim 12, wherein the region of said seat surface having the increased slip resistance corresponds substantially to a surface area selected from the group consisting of ½, ⅓, ¼, ⅛, or 1/10 of an extent of a surface area of said seat surface.
